(19) United States
(12) Patent Application Publication
(10) Pub. No.: US 2018/0067992 A1
(43) Pub. Date: Mar. 8, 2018

(54) DIVIDE-AND-CONQUER GLOBAL ALIGNMENT ALGORITHM FOR FINDING HIGHLY SIMILAR CANDIDATES OF A SEQUENCE IN DATABASE

(71) Applicant: Academia Sinica, Taipei (TW)

(72) Inventors: Wen-Lian HSU, New Taipei City (TW); Hsin-Nan LIN, New Taipei City (TW)

(21) Appl. No.: 15/694,365

(22) Filed: Sep. 1, 2017

Related U.S. Application Data
(60) Provisional application No. 62/384,342, filed on Sep. 7, 2016.

(51) Int. Cl. G06F 17/30

(52) U.S. Cl. CPC G06F 17/30513; G06F 17/30598

(57) ABSTRACT

A divide-and-conquer global alignment algorithm for finding highly similar candidates of a sequence in database is disclosed. The invention gives a divide-and-conquer algorithm called Kart, that separates the given sequence into smaller pieces whose alignment can be carried out independently, and their concatenated alignment constitutes the global alignment of the entire sequence. Kart could be viewed as aligning multiple seeds simultaneously in parallel. We illustrate the idea using the read mapping of Next-generation sequencing (NGS) as an example. NGS provides a great opportunity to investigate genome-wide variation at nucleotide resolution. Due to the huge amount of data, NGS applications require very fast alignment algorithms. The invention can process long reads as fast as short reads. Furthermore, it can tolerate much higher error rates. The experiments show that Kart spends much less time on longer reads than most aligners and still produce reliable alignments.

### BACKGROUND OF THE INVENTION

### Field of the Invention

The present invention relates to a divide-and-conquer algorithm, particularly to a divide-and-conquer global alignment algorithm for finding highly similar candidates of a sequence in database.

### Description of the Related Art

Next-generation sequencing (NGS) allows biologists to investigate genome-wide variation at nucleotide resolution. It has contributed to numerous ground-breaking discoveries and become a very popular technique for sequencing DNA and characterizing genetic variations in populations. Since new sequencing technologies can produce reads on the order of million/billion base-pairs in a single day, many NGS applications require very fast alignment algorithms. The traditional sequence alignment approaches, like BLAST [1] or BLAT [2], are unable to deal with the huge amount of short reads efficiently. Consequently, many aligners for NGS short reads have been developed in recent years. They can be classified into two categories according to their indexing methods: hash tables and suffix array/BWT. A hash table based aligner uses all the subsequences of k-mers to obtain the occurrence locations. In contrast, a suffix array/BWT based aligner finds the maximal exact matches (MEM) between the read sequence and the reference genome. Each category of read aligners has its own merits and deficiencies. However, suffix array/BWT based aligners are more popular due to the efficiency of memory consumption.

Aligners based on hash tables include CloudBurst [3], Eland (proprietary), MAQ [4], RMAP [5], SeqMap [6], SHRiMP [7], ZOOM [8], BFAST [9], NovoAlign (proprietary), SSAHA [10], and SOAPv1 [11]. Most hash table based aligners essentially follow the same seed-and-extend strategy [12]. A representative algorithm of this strategy is BLAST. BLAST keeps the occurrence locations of each k-mer of the database sequences in a hash table and then uses the given query's k-mers to scan and find exact matches by looking up the hash table. An exact match is used as a seed to extend the alignment using Smith-Waterman algorithm between the query and the reference sequence.

Aligners based on suffix array or using Burrows-Wheeler transform (BWT) [13] include Bowtie [14, 15], BWA [16], BWA-SW [17], BWA-MEM (Heng Li), SOAPv2 [18], CUSHAW [19], Subread [20], HISAT/HISAT2 [21], HPG-aligner [22] and segemehl [23]. Most aligners in this category rely on a suffix array to identify the maximal exact matches (called MEMs) and then build alignments based on the exact matches, which is also similar to the seed-and-extend methodology. One exception is the Subread aligner, which adopts a seed-and-vote step to determine the mapped genomic location with multiple seeds from a read sequence. The major advantage of using suffix arrays is that repetitive subsequences need to be aligned only once because they are collapsed onto a single path [12].

Though current short read aligners provide solutions for mapping the massive amount of read sequences produced by NGS technologies, some are not fast enough and some are not accurate enough. Moreover, the third generation sequencing technologies raise further challenges for data analysis, namely, extremely long read sequences and much higher error rate. For example, the PacBio RS II system can generate reads in the length of 5,500 bp to 8,500 bp on average, but the single-read accuracy is only about 87%. Most short read aligners have difficulty in processing those read sequences.

Keeping in mind all these challenges, we developed an alignment algorithm, called Kart, which uses both BWT array and hash table. Kart adopts a divide-and-conquer strategy, which separates a read into regions that are easy to align and regions that require gapped alignment, and align each region independently to compose the final alignment. In our experiments, the average size of fragments requiring gapped alignment is around 20 regardless of the original read length. The experiments on synthetic datasets show that Kart spends much less time on longer reads (150 bp to 7000 bp) than most aligners do, and still produces reliable alignments when the error rate is as high as 15%. The experiments on real datasets further demonstrate that Kart can handle reads with poor sequencing quality.

### SUMMARY OF THE INVENTION

A primary objective of the present invention is to provide a divide-and-conquer global alignment algorithm for finding highly similar candidates of a sequence in database, which can process long reads as fast as short reads. Furthermore, it can tolerate much higher error rates. The present invention can spend much less time on longer reads than most aligners and still produce reliable alignments even when the error rate is as high as 15%.

To achieve the abovementioned objectives, the present invention provides a divide-and-conquer global alignment algorithm for finding highly similar candidates in a database for a query sequence Q, which comprises steps: the database contains at least one reference sequence; identifying all locally maximal exact matches as simple region pairs in the database with the sequence Q, and then clustering the simple region pairs according to their coordinates in the database to form the bases of global alignment; and fixing the overlaps between adjacent simple region pairs and then filling gaps between adjacent simple region pairs by inserting normal region pair to produce a complete alignment.

In one embodiment, a gap between the adjacent simple region pairs represents a problematic region which includes substitutions, insertions or deletions between the query sequence and the reference sequence. When the normal pair is NP-gap free, a linear scan is sufficient, which greatly reduces the alignment time.

Below, embodiments are described in detail in cooperation with the attached drawings to make easily understood the objectives, technical contents, characteristics and accomplishments of the present invention.

### BRIEF DESCRIPTION OF THE DRAWINGS

FIG. 1 schematically shows the algorithm to explore all LMEMs with length≧k. LMEM_Search is the function to search for the occurrences of the maximal exact match for R[start, stop] on the given BWT array. It returns an LMEM as well as all its occurrences on the reference genome.

FIG. 2 schematically shows simple pair A overlaps with simple pair B according to one embodiment of the present invention. Kart removes the overlap by shrinking the size of the smaller simple pair.

FIG. 3 schematically shows simple pairs and normal pairs. A read sequence can be decomposed into different parts according to the alignment with the genome sequence. A simple pair represents a pair of sequence fragments which are exact matches; a normal pair represents a pair of sequence fragments which contains some sequence differences in the alignment.

### DETAILED DESCRIPTION OF THE INVENTION

Most traditional global alignment algorithms for finding similar candidates of a sequence in sequence database adopt seed-and-extension approach, which is based on a sequential dynamic programming algorithm. This invention gives a divide-and-conquer algorithm called Kart, that separates the given sequence into smaller pieces whose alignment can be carried out independently and in parallel, and their concatenated alignment constitutes the global alignment of the entire sequence. Kart could be viewed as aligning multiple seeds simultaneously in parallel. We illustrate the idea using the read mapping of Next-generation sequencing (NGS) as an example.

Reference will now be made in detail to the preferred embodiments of the present invention, examples of which are illustrated in the accompanying drawings. Wherever possible, the same reference numbers are used in the drawings and the description to refer to the same or like parts.

### Methods

### Overview of Algorithms

Most suffix/BWT array based aligners, which follow the canonical seed-and-extend methodology, initiate an alignment with an MEM (seed) and extend the alignment with different dynamic programming strategies. Therefore, the performance of an aligner is greatly affected by the algorithms for seed exploration and the strategies for handling inexact matches. These aligners are sequential in nature. We adopted a divide-and-conquer strategy to reduce the time-consuming gapped alignment step using dynamic programming, which is suitable for mapping highly similar fragment sequences (each read is essentially a copy of a specific genome fragment except for a small percentage of sequencing errors).

### Simple Pairs and Normal Pairs

Since un-gapped (without indels) alignment is much faster than gapped alignment, for each mapped candidate region in the reference genome, we separate the given read sequence and their candidate regions into two groups: simple region pairs (abbreviated as simple pairs) and normal region pairs (normal pairs), where all simple pairs have perfect alignment (exact matches), and normal pairs require un-gapped/gapped alignment. Once the simple and normal pairs are identified, they can be processed and aligned independently and the final mapping result for a candidate region is simply the concatenation of the alignment of each simple and normal pair.

Consider a read sequence R, the reference genome G, and the BWT array constructed from G and its reverse sequence G′. For simplicity and without losing generality, we assume G is the concatenation of G and G′ in the remainder of the paper. Let R[i₁] be the i₁-th nucleotide of R, and R[i₁, i₂] be the subsequence between R[i₁] and R[i₂]. Similarly, let G[j₁] be the j₁-th nucleotide of G, and G[j₁, j₂] be the subsequence between G[j₁] and G[j₂]. A locally maximal exact matches (LMEMs) on a given BWT array of length l is defined as a maximal exact match between R[i₁, i₂] (called the read block) and G[j₁, j₂] (called the genome block), where i₂−i₁=j₂−j₁=l−1 and is denoted by a 4-tuple (i₁, i₂, j₁, j₂). We use ΔPos=(j₁−i₁) to represent the position difference between the read and genome block.

### Finding all LMEMs for the Given Read Sequence

Since an LMEM represents an identical fragment pair between R and G, it is considered as a simple pair in this invention. Kart finds all LMEMs via traversing a BWT array. An LMEM exploration starts from R[i₁] and stops at R[i₂] if the exact match extension reaches a mismatch at R[i₂+1]. In such cases, the next LMEM exploration will skip R[i₂+1] and starts from R[i₂+2] because R[i₂+1] is very likely a sequencing error or sequence variation. Kart only considers an LMEM (i₁, i₂, j₁, j₂) as a qualified simple pair if its length is no less than a predefined threshold k and its occurrence is less than 50. The value k is typically between 10 and 16, and is determined based on the size of the reference genome. Intuitively, a short LMEM (<k bp) might contain erroneous bases and would less likely include the true coordinate. A larger genome needs a larger k for a compromise between specificity and sensitivity.

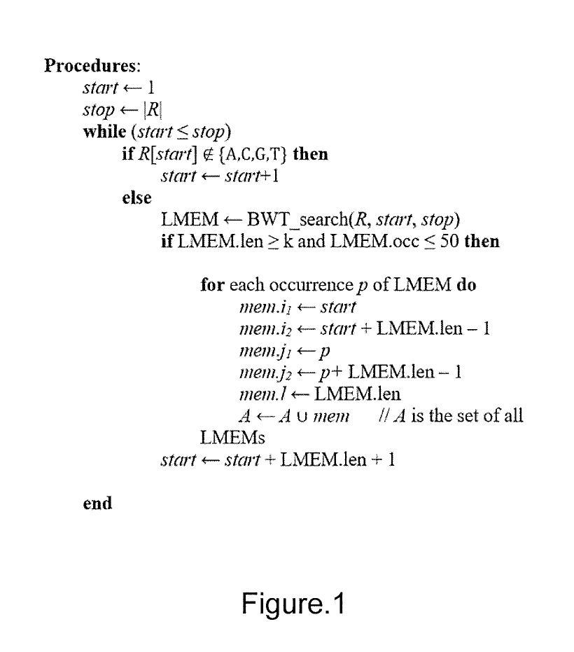

FIG. 1 shows the algorithm of the LMEM exploration procedure. The function BWT search is a general BWT traversal method which takes a read sequence as the input and returns desirable LMEMs as well as their occurrences in the reference genome. If there are no sequencing errors or variations, there should be only one LMEM which covers the whole read sequence (i.e., LMEM.len=|R|). However, in reality, sequencing errors and variations happen a lot and they break a read into several LMEMs with variable lengths. Kart considers all qualified LMEMs as simple pairs, and identifies normal pairs according to the distribution of simple pairs to create one or more candidate alignments.

### Identifying Simple Pairs and Normal Pairs

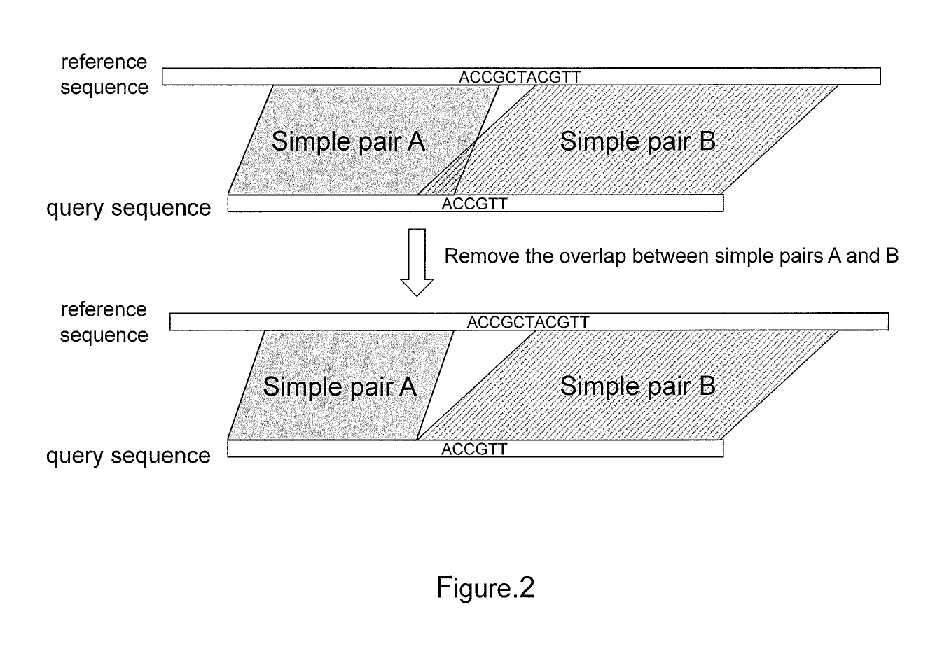

Since the same read can be mapped to multiple genome regions if it originates from a repetitive sequence, these simple pairs can also spread all over the genome. A candidate alignment is defined as an alignment between the read and a specific region on the reference genome. To identify all candidate alignments for the read, we cluster all adjacent simple pairs whose ΔPos differences are smaller than a predefined threshold g (the default value is 5). Therefore, neighboring simple pairs whose ΔPos differences<g are clustered together to form a candidate alignment. Note that two simple pairs in a candidate alignment could overlap due to tandem repeats, sequence variations or overlapping LMEMs (when doing 8-LMEMs, as explained in subsection 2.5). If two simple pairs overlap in a candidate alignment, say, in the genome portion (the same goes for the read portion), we chop off the overlapped portion in the genome and its corresponding read portion from the shorter pair to ensure that all simple pairs are non-overlapping. FIG. 2 illustrates an example of two overlapped simple pairs, in which simple pair A overlaps with simple pair B due to sequence variation at that corresponding region. Kart removes the overlap by shrinking the shorter simple pair, say A. In this way, any two simple pairs in the same candidate alignment will not share any nucleotide.

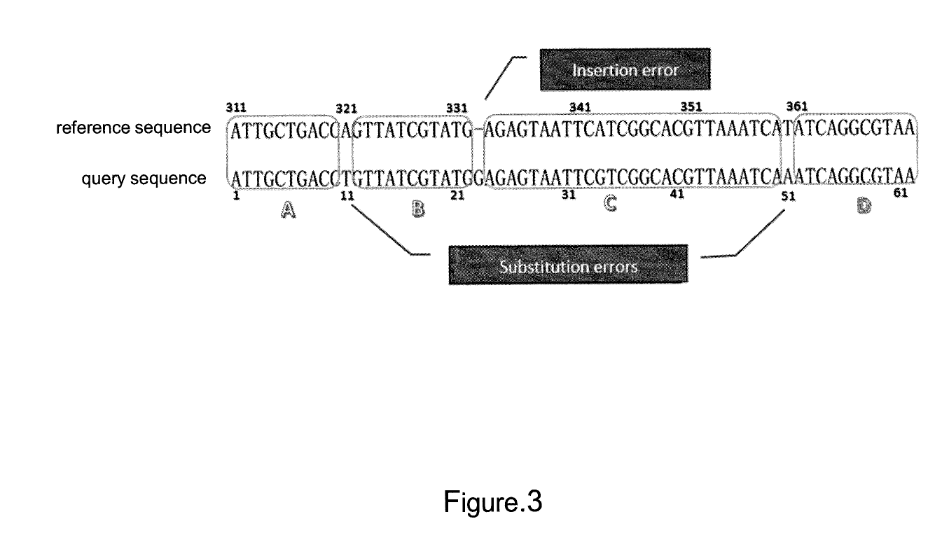

We then create normal pairs filling the gaps between adjacent simple pairs to make a complete alignment as follows. Suppose two neighboring simple pairs are (i_{2q-1}, i_{2q}, j_{2q-1}, j_{2q}) and (i_{2q+1}, i_{2q+2}, j_{2q+1}, j_{2q+2}) respectively, and they must have i_{2q+1}−i_{2q}>1 or j_{2q+1}−j_{2q}>1, Kart inserts a normal pair to fill the gaps between the two regions. In such cases, a normal pair (iᵣ, iᵣ₊₁, jᵣ, jᵣ₊₁) is inserted where iᵣ−i_{2q}=i_{2q+1}−iᵣ₊₁=1 if i_{2q+1}−i_{2q}>1, otherwise let iᵣ=iᵣ₊₁=−1 (i.e., a null base). Likewise, jᵣ−j_{2q}=j_{2q+1}−jᵣ₊₁=1 if j_{2q+1}−j_{2q}>1, otherwise let jᵣ=jᵣ₊₁=−1. On the other hand, if the first (or the last) simple region in a candidate alignment does not cover the first (or the last) nucleotide of the read sequence, a normal pair would also be created to fill the gap. FIG. 3 gives an example illustrating the concept of simple and normal pairs. In this example, the read sequence contains three substitution errors as well as an insertion error of size two. After the LMEM exploration, we can identify four simple pairs (labelled A, B, C, and D). However, these four simple pairs do not cover the whole read sequence. Thus, we check every adjacent simple pairs and generate the corresponding normal pair according to the gaps in between: we generate the normal pair (11, 11, 321, 321) between simple pairs A and B; likewise, we generate the normal pair (23, 24, −1, −1) between simple pairs B and C, and the normal pair (49, 51, 357, 359) between simple pairs C and D. Thus, all of these simple pairs and normal pairs together form a complete alignment candidate.

### Four Types of Normal Pairs

Simple pairs are formed from LMEMs with perfect matches. They partition the read sequence into interlaced simple and normal region pairs, which can be independently aligned and the final alignment is simply the concatenation of the alignment of each simple and normal pair. A closer look at the normal pairs indicates that a substantial portion of normal pairs do not require gapped alignment either. When both the read block and the genome block of a normal pair are more than 30 bp long, we perform a second round of sequence partition operation to further divide it and reduce the portion that needs gapped alignment. This time, we look for LMEMs of size≧8 bp within such normal pair. Since the size of such normal pair is much smaller than the whole genome, 8-mer index (from a hash table constructed on the fly) is used to identify matched 8-mer seeds between the read block and the genome block. These seeds were extended to LMEMs, referred to as 8-LMEMs. These 8-LMEMs could further separate a longer normal pair into shorter ones.

When processing PacBio reads, if a normal pair (without 8-LMEMs) at the end of a read has length more than 5000, then its corresponding read block is simply clipped from further consideration, and we only perform a local alignment for that read to avoid making an alignment in a poor quality region. When processing Illumina reads, we found that if the read block and genome block of a normal pair have equal size, then it is very likely the normal pair only contains substitution errors and the un-gapped alignment gives rise to the best alignment for such pair; however, if a normal pair contains indel errors, the un-gapped alignment will result in low sequence identity. So, by checking the percentage of mismatches with a linear scan, we can determine whether a normal pair requires gapped alignment or not. Moreover, Illumina reads could contain adaptor sequences or become chimera with a tiny probability. We check the sequence identity of the normal block at both ends of a read and remove the one whose sequence identity is <50%. In such cases, Kart clips the corresponding read block and report a local alignment instead. Summarizing the above discussion, we divided the normal pairs into the following four types:
1. A normal pair is a NP-clip if (1) it is at the ends of a PacBio read and its length is more than 5000 or (2) it is at the ends of an Illumina read and its sequence identity is <50%.
2. A normal pair is a NP-gap free if its read block and genome block have equal size, and its number of mismatches in a linear scan is less than 20% of the block size.
3. A normal pair is a NP-indel if one of the fragment (either its read block or genome block) is an empty string and the other contains at least one nucleotide.
4. The remaining normal pairs are referred to as NP-NWs, which require Needleman-Wunsch algorithm for gapped alignment.

Disregarding those NP-clips, one can see from Table 3 that those NP-NWs requiring gapped alignment were sufficiently separated so that their average lengths are around 20 for different datasets, which can be processed much faster than the original read.

### Paired-End Reads Mapping

Paired-end reads are two reads that are physically associated within a certain distance from each other. They can help reduce mapping ambiguity and increase mapping reliability. Kart supports paired-end reads mapping as follows. To align paired-end reads, Kart finds the candidate alignments for each read separately and then compare the two groups of mapping results to see if there is a pair of alignments one from each group that satisfies the paired-end distance constraints. If there is no such pair, it implies that the paired-end reads contain more sequencing errors such that at least one of them is not mapped properly. In such cases, Kart will initiate a rescue procedure trying to find a proper pair of alignments based on the candidate alignments of the opposite read. The implementation of the rescue procedure is described in detail below.

Suppose G₁ and G₂ are the two groups of candidate alignments corresponding to paired-end reads R₁ and R₂. Let G₁={m₁, m₂, . . . , mₚ} and G₂={n₁, n₂, . . . , n_{q}} where m₁, m₂, . . . , and mₚ represent candidate alignments of R₁; n₁, n₂, . . . , and n_{q} represent candidate alignments of R₂. For each alignment m in G₁ with the coordinate c, Kart tries to map R₂ onto the downstream region of c according to the mapping procedure described above, but the LMEM length threshold is set to 10 to increase the sensitivity of the mapping. In doing so, Kart is able to compromise the noises of R₂ and identify the best alignment n′ in the downstream region of R₁ 's alignment. Kart repeats the same procedure using each alignment n in G₂ to find the best alignment m′ for R₁ in the upstream region of n. At this moment, both the pair of mᵢ and n′ and m′ and nⱼ meet the paired-end constraint, and we select the pair with the highest sequence identity of the alignments.

### Summary of Our Algorithms

Given a read sequence R, Kart identifies all LMEMs with variable lengths along the read sequence by the BWT search against the reference sequences. Each LMEM is turned into a simple pair or more if it appears multiple times in the reference. Adjacent simple pairs are then clustered according to their ΔPos. After removing overlaps between adjacent simple pairs, Kart fills in the gaps between simple pairs with normal pairs to make each cluster a complete candidate alignment. When both the read block and the genome block of a normal pair are more than 30 bp long, we perform a second round of sequence partitioning to further divide it and reduce the portion that needs gapped alignment. The final read alignment is the concatenation of simple/normal pairs in the same candidate alignment. Finally, Kart reports the alignment with the highest alignment score or paired alignments for paired-end reads.

### Results

### Implementation and Experiment Design

Kart was developed under Linux 64-bit environment and implemented with standard C/C++. It supports multi-thread to take advantage of multi-core computers. Kart reads a BWT-based indexing file and a read library (single-end or paired-end reads) in FASTA/FASTQ format as input and it reports read alignments in the SAM (Sequence Alignment/Map) format [24].

It is difficult to estimate the correctness of read alignments using real datasets since the actual chromosomal coordinate of each read sequence is unknown. Therefore, we simulated read libraries to estimate the performance of read aligners. Here, we simulated read libraries of the human genome (Hg19) using the wgsim program (https://github.com/lh3/wgsim) to produce the synthetic datasets. All the Illumina-like simulated read libraries were generated with default setting of the wgsim. It altered the genome sequences with 0.1% of mutation rate (15% of which are INDELs and 85% are SNPs) to simulate polymorphisms. In turn, wgsim generated synthetic reads with 2% of substitution sequencing errors.

We also simulated PacBio-like reads using the wgsim program with 13% of mutation rate (all INDEL polymorphisms) and an additional 2% of substitution sequencing errors for Hg19. It can be expected that reads from new sequencing technologies are getting longer [17]. For example, the latest Illumina MiSeq System can generate reads of 300 bp long. Therefore, in this article, we simulated ten million pair-end reads of 100 bp, 150 bp, and 300 bp long for Illumina-like data and one million single-end reads of 7000 bp long for PacBio-like data. For the convenience of describing these synthetic libraries, Hg19_L150_E02 represents the Illumina-like library with 150 bp read length and 2% of error rate of Hg19. Hg19_L7000_E15 represents the PacBio-like library with 7000 bp read length and 15% of error rate (13% of indels and 2% of substitutions). To assess the performance on real data, we randomly downloaded four datasets from NCBI SRA, Illumina and PacBio web sites, which are SRR622458, SRR826460, SRR826471, and M130929 (http://datasets.pacb.com/2014/Human54x/fasta.html). The first three datasets were produced by Illumina sequencers, and the last one was by PacBio sequencer. All the datasets were from human genome samples.

We used precision, recall (also referred to as accuracy in this article) and running time to estimate the performance of read alignments on simulated data. A read is considered a true positive (TP) if its mapping coordinate is within a distance of 30 bp to the original coordinate. Given a library with N reads and n out of N are mapped with at least one alignment, the precision and recall are defined as the following percentages:

precision=# of TPs/n×100%;

ecall=# of TPs/N×100%.

Therefore, if every input read is mapped, precision is equal to recall. To avoid estimation bias due to multiple hits (i.e., ambiguous mapping), we only evaluated the first alignment for each read. For real data, we measure the sensitivity (also referred to as mapping rate) and runtime, where sensitivity is the percentage of reads with at least one alignment relative to all input reads, namely,

sensitivity=n/N×100%.

Since the actual coordinates of real data are unknown, we evaluate the mapping quality by calculating the number of identical base pairs in an alignment. The reason is that the best alignment will likely have the maximal number of identical base pairs.

All reads in the test data were processed on a Linux 64-bit system with 4 Intel Xeon E7-4830 2.13 GHz CPUs and 2 TB physical memory. We compared Kart with several existing read aligners: BWA-MEM, Bowtie2, Cushaw3, HISAT2, HPG-aligner, Subread, LAST [25], Minimap [26] and BLASR [27] (the last three are for PacBio data only). The other aligners which were not considered in this article are those which do not support multi-threading or do not accept the format of test data (such as Gassst, Ssaha2, and NovoAlign), plus those which could not be run properly in our system or took much more time to process the test data (such as GEM, hobbes, and razers3).

The selected aligners represent state-of-the-art NGS short read mappers and are widely used in NGS data analysis. We tried to use the default parameter settings to test each aligner unless the performance was not satisfactory. We also forced each aligner to only report the best alignment or a random best if there were multiple hits by setting the parameters. All aligners were run with 16 threads to speed up the alignment procedure.

### Evaluation on Illumina-Like Simulated Data Sets

Table 1 shows the evaluation result for the selected aligners on the Illumina-like libraries of Hg19. From Table 1, we can see that most selected aligners produced comparable alignments on read libraries with different read lengths, where their precisions and recalls ranged from 97 to 99%. In fact, most of the incorrect alignments were due to the ambiguity of repetitive regions. In most cases, the alignment accuracies were improved when the read length became longer. For example, the alignment accuracies of Kart on Hg19_L100_E02, Hg19_L150_E02, and Hg19_L300_E02 were 97.8%, 98.5%, and 99.1%, respectively; and those of BWA-MEM were 98.6%, 98.9% and 99.2%, respectively. Bowtie and HISAT2 were less sensitive when aligning longer reads. In particular, HISAT2's recall on Hg19_L300_E02 was 53.6%.

In terms of runtime, it can be seen that Kart was the fastest aligner among all considered algorithms. In this analysis, the runtime of Kart on the three simulated datasets was 53, 66, and 113 seconds, respectively. Thus, our divide-and-conquer strategy provides a much faster solution for NGS read mapping, especially for longer reads.

### Evaluation on PacBio-Like Simulated Data Sets

Table 1 also shows the evaluation result on one million PacBio-like reads. Because PacBio-like reads contain much more insertion/deletion errors, a read is considered to be correctly aligned if the mapping coordinate is within a distance of 100 bp to the original coordinate. In this evaluation only Kart, BWA-MEM, LAST, Mimimap and BLASR were compared because the others were not designed for aligning long reads in PacBio data. In Table 1, Kart, BWA-MEM, LAST and BLASR yielded similar recall on the PacBio simulated data. It shows that these aligners were capable of dealing with very long reads with high error rate. However, Kart was much faster: the runtime of Kart was 733 seconds, and that of BWA-MEM, LAST and BLASR was 4614, 78432, and 9185, respectively. Though Minimap took the least amount of time (288 seconds), its mapping accuracy was only 83.4%. It is noteworthy that Minimap is not a regular read aligner since it does not generate alignments. It can only identify long approximate matches quickly. Therefore, we did not evaluate Minimap on real PacBio dataset.

TABLE 1
Illumina and PacBio-like simulated data. Ten million paired-end reads of
100 bp, 150 bp, and 300 bp and one million single-end reads of 7000 bp
were simulated from human genome (Hg19) with wgsim simulator.

| Synthetic | | | | |
|---|---|---|---|---|
| datasets | Aligner | Precision | Recall | Runtime |
| Hg19_L100_E02 | Kart | 97.8 | 97.8 | 53 |
| | Bowtie2 | 96.3 | 95.8 | 149 |
| | BWA-MEM | 98.6 | 98.6 | 403 |
| | Cushaw3 | 98.2 | 98.2 | 1412 |
| | HPG-Aligner | 97.7 | 97.5 | 146 |
| | HISAT2 | 95.3 | 92.7 | 78 |
| | Subread | 98.5 | 93.4 | 353 |
| Hg19_L150_E02 | Kart | 98.4 | 98.4 | 66 |
| | Bowtie2 | 96.2 | 96.2 | 266 |
| | BWA-MEM | 98.9 | 98.9 | 581 |
| | Cushaw3 | 98.6 | 98.6 | 1278 |
| | HPG-Aligner | 98.5 | 98.5 | 315 |
| | HISAT2 | 92.3 | 89.4 | 91 |
| | Subread | 98.0 | 96.9 | 474 |
| Hg19_L300_E02 | Kart | 99.0 | 99.0 | 113 |
| | Bowtie2 | 96.1 | 96.1 | 718 |
| | BWA-MEM | 99.2 | 99.2 | 1096 |
| | Cushaw3 | 99.1 | 99.1 | 3085 |
| | HPG-Aligner | 99.1 | 99.1 | 317 |
| | HISAT2 | 70.5 | 54.6 | 155 |
| | Subread | 98.8 | 98.8 | 774 |
| Hg19_L7000_E15 | Kart | 99.6 | 99.6 | 733 |
| | BWA-MEM | 99.8 | 99.8 | 4614 |
| | LAST | 99.9 | 99.4 | 78432 |
| | Minimap | 83.4 | 83.4 | 288 |
| | BLASR | 99.8 | 99.8 | 9185 |

### Evaluation on Real Data Sets

In additional to synthetic datasets, we also downloaded four real datasets of whole human genome from NCBI SRA, Illumina, and PacBio web sites, which are

SRR622458 (40 million 101 bp paired-end Illumina reads).

SRR826460 (40 million 150 bp paired-end Illumina reads).

SRR826471 (34 million 250 bp paired-end Illumina reads).

M130929 (1.2 million 7118 bp single-end PacBio reads).

Table 2 summarizes the evaluation result on these datasets. In this evaluation, we use the sensitivity and the average number of identical bases to estimate the quality of alignments. It can be seen that Kart spent the least amount of time on mapping the reads in these real datasets. Kart was several times faster than alternative aligners. Kart also produced the largest number of identical base pairs on most of the datasets (sensitivity×average identical bases). Take SRR622458 for example. Kart produced alignments with 98.6% of sensitivity and 99 of identical bases on average. BWA-MEM, Bowtie2, and Cushaw3 produced comparable alignments with Kart, but they spent more time on the alignments. Note that HPG-aligner failed to finish all reads in SRR622458 due to unknown reasons. Some aligners left more reads unmapped. HISAT2 only produced 86.0%, 91.9%, and 43.9% of sensitivity on the three Illumina datasets.

For the experiment result on the PacBio dataset M130929, Kart and BLASR produced comparable alignments on the 1.2 million PacBio reads. However, BLASR spent more time than Kart. BWA-MEM ran faster than BLASR, but its sensitivity and average number of identical pairs are not as good as those on Illumina datasets. LAST's speed ranked last, but it produced comparable alignments with Kart and BLASR.

We further compared memory usage of each selected aligner. Though some aligners allow users to set the maximum memory usage for read mapping, we did not set any limit and let the aligner take as much memory as it needs to speed up the mapping process. In Table 2, we found that each aligner consumed similar amount of memory on different datasets. BWA-MEM, Bowtie2, Cushaw3, and HISAT2 required less memory (<10 GB). Kart and Subread required 12 GB and 18 GB, respectively, and HPG-aligner and BLASR required around 30 GB.

TABLE 2
Experiment result on the four real data sets with different read lengths.

| Real | | | Identical | MEM | |
|---|---|---|---|---|---|
| datasets | Aligner | Sensitivity | base pairs | (Gb) | Runtime |
| SRR622458 | Kart | 98.6 | 99 | 12 | 158 |
| Illumina- | Bowtie2 | 97.4 | 99 | 4.5 | 458 |
| 101 bp | BWA-MEM | 98.8 | 97 | 8.5 | 1157 |
| | Cushaw3 | 99.1 | 98 | 4.8 | 9063 |
| | HPG- | NA | NA | 31.2 | NA |
| | Aligner | | | | |
| | HISAT2 | 86.0 | 99 | 5.5 | 298 |
| | Subread | 91.2 | 97 | 18.4 | 1362 |
| SRR826460 | Kart | 99.3 | 149 | 12 | 186 |
| Illumina- | Bowtie2 | 98.4 | 149 | 4.5 | 769 |
| 150 bp | BWA-MEM | 99.3 | 147 | 8.5 | 1374 |
| | Cushaw3 | 99.3 | 148 | 4.8 | 10736 |
| | HPG- | 98.3 | 147 | 31.2 | 1204 |
| | Aligner | | | | |
| | HISAT2 | 91.9 | 149 | 5.5 | 371 |
| | Subread | 97.5 | 147 | 18.4 | 2694 |
| SRR826471 | Kart | 98.6 | 237 | 12 | 395 |
| Illumina- | Bowtie2 | 94.7 | 237 | 4.5 | 1729 |
| 250 bp | BWA-MEM | 98.6 | 220 | 8.5 | 3027 |
| | Cushaw3 | 98.4 | 232 | 4.6 | 37689 |
| | HPG- | NA | NA | 27.9 | NA |
| | Aligner | | | | |
| | HISAT2 | 43.9 | 247 | 5.5 | 461 |
| | Subread | NA | NA | 18.4 | NA |
| M130929 | Kart | 100.0 | 5152 | 13 | 1811 |
| PacBio- | BWA-MEM | 90.7 | 2953 | 9 | 7338 |
| 7118 bp | LAST | 97.2 | 5022 | 15 | 31295 |
| | BLASR | 97.8 | 5389 | 28.9 | 18682 |

### Efficiency of Kart's Divide-and-Conquer Strategy

The performance analysis on simulated datasets shows that Kart is an efficient algorithm for NGS read mapping. We adopt a divide-and-conquer strategy to separate a read sequence into simple pairs and normal pairs, and align each pair independently. A simple pair has a perfect match, but a normal pair requires more time to find its best alignment. Hence, if the fraction of the normal pairs is smaller, and the fragment sizes are shorter, the read can be mapped faster.

To demonstrate the efficiency of Kart's divide-and-conquer strategy with different read lengths, we analyzed the average sizes of simple and normal pairs on the four real datasets. Table 3 shows the average sizes of all fragment pairs after two rounds of sequence partition, namely, LMEM-seed, 8-LMEM-seed, NP-gap free, NP-indels, and NP-NW. Note that, fragment pairs in the first four groups do not require gapped alignment, only those in the last group do. Take SRR622458 as an example, the average size of LMEM-seed is 73 bp, and 96.5% nucleotides belong to this group. When applying the normal pair partitioning with 8-mers, we could identity 8-LMEM-seeds with 11.4 bp on average. The most time consuming fragment pairs, the NP-NWs, are 17.5 bp on average, and only 1.9% nucleotides fall into this group. SRR826460 shows similar result with SRR622458, though SRR826471 has much higher ratio in the group of NP-NW, which suggests that Illumina yields higher error rates on 250 bp long reads. For the real PacBio dataset, it is observed that the average size of LMEM-seed is 21.3 bp, and only 13.7% of nucleotides fall into this group; however, the second round of seeding could identify 8-LMEM-seeds with 12.4 bp on average and 39.7% of nucleotides go to this group; It is noteworthy that the most time consuming group, the NP-NW, only needs to perform DP on 21.3 bp long fragment pairs on average, with 44.3% of all nucleotides.

TABLE 3
The average sizes of simple and normal pairs after two rounds of
sequence partition on Illumina datasets (those NP-clips were not
included in the percentage calculation).

| | LMEM- | 8-LMEM- | NP-gap | NP- | |
|---|---|---|---|---|---|
| Dataset | seed | seed | free | indels | NP-NW |
| SRR622458 | 73.0 | 11.4 | 3.9 | 1.8 | 17.5 |
| | (96.5%) | (0.9%) | (0.7%) | (0%) | (1.9%) |
| SRR826460 | 112.7 | 13.7 | 4.5 | 1.9 | 19.5 |
| | (97.9%) | (0.5%) | (0.7%) | (0%) | (0.9%) |
| SRR826471 | 104.2 | 12.4 | 7.5 | 1.9 | 22.8 |
| | (84.9%) | (3.8%) | (2.5%) | (0%) | (8.8%) |
| M130929 | 21.3 | 12.4 | 10.8 | 1.4 | 21.3 |
| | (13.7%) | (39.7%) | (0.1%) | (2.6%) | (44%) |

### CONCLUSIONS

Here we present Kart, a new sequence aligner for sensitive, rapid, and accurate mapping from NGS reads to a reference genome. We use a BWT array to produce an alignment consisting of simple pairs and normal pairs. Each simple pair represents an identical fragment pairs between the query sequence and the reference genome, and each normal pair represents a highly similar fragment pairs. We show that Kart's divide-and-conquer strategy can reduce the required dynamic programming process and save considerable amount of time, especially for mapping long read sequences. In our evaluation analysis on simulated reads and real data, Kart yields the best or comparable alignments and spends the least amount of time.

PacBio reads are usually difficult to map efficiently because of their extremely long sequences and high sequencing error rate. From the analysis results on simulated and real PacBio datasets, Kart not only can generate accurate alignments, but also spends much less time than others. With the improved sequencing technology, new high-throughput sequencers are likely to generate much longer reads with varied quality. Experiment results show that Kart is an appropriate aligner that can produce efficient and accurate alignments for reads with various lengths and quality.

In this invention, we only demonstrated the efficiency of the divide-and-conquer algorithm with the problem of DNA-Seq read mapping. In fact, this algorithm can also be applied to the problem of RNA-Seq read mapping and genome sequence comparison. One of the features of our method is the fast mapping of identical subsequences between two sequences, and the identification of un-gapped normal pairs, which separate the read into smaller regions that can aligned independently and in parallel. All these identified regions can be aligned separately and the final alignment is the concatenation of these sub-alignments.

### REFERENCES

1. Altschul, S. F., et al., Basic local alignment search tool. J Mol Biol, 1990. 215(3): p. 403-10.
2. Kent, W. J., BLAT—the BLAST-like alignment tool. Genome Res, 2002. 12(4): p. 656-64.
3. Schatz, M. C., CloudBurst: highly sensitive read mapping with MapReduce. Bioinformatics, 2009. 25(11): p. 1363-9.
4. Li, H., J. Ruan, and R. Durbin, Mapping short DNA sequencing reads and calling variants using mapping quality scores. Genome Research, 2008. 18(11): p. 1851-1858.
5. Smith, A. D., Z. Y. Xuan, and M. Q. Zhang, Using quality scores and longer reads improves accuracy of Solexa read mapping. Bmc Bioinformatics, 2008. 9.
6. Jiang, H. and W. H. Wong, SeqMap: mapping massive amount of oligonucleotides to the genome. Bioinformatics, 2008. 24(20): p. 2395-2396.
7. Rumble, S. M., et al., SHRiMP: Accurate Mapping of Short Color-space Reads. Plos Computational Biology, 2009. 5(5).
8. Lin, H., et al., ZOOM! Zillions of oligos mapped. Bioinformatics, 2008. 24(21): p. 2431-2437.
9. Homer, N., B. Merriman, and S. F. Nelson, BFAST: An Alignment Tool for Large Scale Genome Resequencing. Plos One, 2009. 4(11): p. A95-A106.
10. Ning, Z., A. J. Cox, and J. C. Mullikin, SSAHA: a fast search method for large DNA databases. Genome Res, 2001. 11(10): p. 1725-9.
11. Li, R. Q., et al., SOAP: short oligonucleotide alignment program. Bioinformatics, 2008. 24(5): p. 713-714.
12. Li, H. and N. Homer, A survey of sequence alignment algorithms for next-generation sequencing. Brief Bioinform, 2010. 11(5): p. 473-83.
13. Wheeler, M. B. a. D. J. W. a. M. B. a. D. J., A block-sorting lossless data compression algorithm. SRC Research Report, 1994(124).
14. Langmead, B., et al., Ultrafast and memory-efficient alignment of short DNA sequences to the human genome. Genome Biol, 2009. 10(3): p. R25.
15. Langmead, B. and S. L. Salzberg, Fast gapped-read alignment with Bowtie 2. Nat Methods, 2012. 9(4): p. 357-9.
16. Li, H. and R. Durbin, Fast and accurate short read alignment with Burrows-Wheeler transform. Bioinformatics, 2009. 25(14): p. 1754-1760.
17. Li, H. and R. Durbin, Fast and accurate long-read alignment with Burrows-Wheeler transform. Bioinformatics, 2010. 26(5): p. 589-95.
18. Li, R. Q., et al., SOAP2: an improved ultrafast tool for short read alignment. Bioinformatics, 2009. 25(15): p. 1966-1967.
19. Liu, Y., B. Schmidt, and D. L. Maskell, CUSHAW: a CUDA compatible short read aligner to large genomes based on the Burrows-Wheeler transform. Bioinformatics, 2012. 28(14): p. 1830-7.
20. Liao, Y., G. K. Smyth, and W. Shi, The Subread aligner: fast, accurate and scalable read mapping by seed-and-vote. Nucleic Acids Research, 2013. 41(10).
21. Kim, D., B. Landmead, and S. L. Salzberg, HISAT: a fast spliced aligner with low memory requirements. Nature Methods, 2015. 12(4): p. 357-U121.
22. Tarraga, J., et al., Acceleration of short and long DNA read mapping without loss of accuracy using suffix array. Bioinformatics, 2014. 30(23): p. 3396-3398.
23. Hoffmann, S., et al., Fast Mapping of Short Sequences with Mismatches, Insertions and Deletions Using Index Structures. Plos Computational Biology, 2009. 5(9).
24. Li, H., et al., The Sequence Alignment/Map format and SAMtools. Bioinformatics, 2009. 25(16): p. 2078-9.
25. Frith, M. C., R. Wan, and P. Horton, Incorporating sequence quality data into alignment improves DNA read mapping. Nucleic Acids Research, 2010. 38(7).
26. Li, H., Minimap and miniasm: fast mapping and de novo assembly for noisy long sequences. Bioinformatics, 2016. 32(14): p. 2103-2110.
27. Chaisson, M. J. and G. Tesler, Mapping single molecule sequencing reads using basic local alignment with successive refinement (BLASR): application and theory. Bmc Bioinformatics, 2012. 13.

What is claimed is:

1. A divide-conquer global alignment algorithm for finding highly similar candidates in a database for a query sequence Q, comprising steps:
the database contains at least one reference sequence;
identifying all locally maximal exact matches as simple region pairs in the database with the sequence Q, and then clustering the simple region pairs according to their coordinates in the database to form bases of global alignment; and
fixing the overlaps between adjacent simple region pairs and then filling gaps between adjacent simple region pairs by inserting normal region pair to produce a complete alignment.

2. The divide-conquer global alignment algorithm according to claim 1, wherein the simple region pairs are found by traversing a Burrows-Wheeler transform (BWT) array or a hash table built from the sequences in database.

3. The divide-conquer global alignment algorithm according to claim 1, wherein the reference sequence is a genome or a chromosome or a contig, and the query sequence is a genome or a chromosome or a contig, or a short piece of genome sequence (NGS read).

4. The divide-conquer global alignment algorithm according to claim 1, wherein a gap between the adjacent simple region pairs represents a problematic region which includes substitutions, insertions or deletions between the query sequence and the reference sequence.

5. The divide-conquer global alignment algorithm according to claim 4, wherein the normal pair is NP-gap free, a linear scan is sufficient.
